(19) United States
(12) Patent Application Publication
(10) Pub. No.: US 2010/0277932 A1
(43) Pub. Date: Nov. 4, 2010

(54) Halation-Free Light-Emitting Diode Holder

(75) Inventors: Ming-Hung Chen, Zhudong Town, Hsinchu County (TW); Shih-Yi Wen, Zhudong Town, Hsinchu County (TW); Hsin-Tai Lin, Zhudong Town, Hsinchu County (TW); Jing-Yi Chen, Zhudong Town, Hsinchu County (TW)

Correspondence Address: Juan Carlos A. Marquez;c/o Stites & Harbison PLLC, 1199 North Fairfax Street, Suite 900, Alexandria, VA, 22314-1437, US

(73) Assignee: Helio Optoelectronics Corporation, Zhudong Town, Hsinchu County (TW)

(21) Appl. No.: 12/745,974

(22) PCT Filed: Jan. 23, 2008
(86) PCT No.: PCT/CN08/00166

§ 371 Date: Jun. 3, 2010

(51) Int. Cl. F21V 21/00

(52) U.S. Cl. 362/382

(57) ABSTRACT

A halation-free light-emitting diode holder includes a body and a retaining portion. The body has a die holder, which includes a first surface, a second surface, and an opened end. The retaining portion is provided on the second surface. By using the retaining portion, the optical gel in the die holder is blocked from capillary movement up along the second surface. Furthermore, having nano-material layers further formed on the second surface or having the area of the first surface made greater than the area of the opened-end also prevents the optical gel from climbing along the second surface. Thereby, a light halation circling a light pattern of the resultant light-emitting diode is avoided and the light-emitting diode is improved in luminance uniformity.

### BACKGROUND OF THE INVENTION

1. Technical Field

The present invention relates to light-emitting diode holders, and more particularly, to a halation-free light-emitting diode holder that prevents a light-emitting diode from giving a light pattern undesirably circled by a light halation so as to improve the luminance uniformity of the light-emitting diode.

2. Description of Related Art

At present, light-emitting diodes have been supplied as red light-emitting diodes, green light-emitting diodes, and blue light-emitting diodes, each giving the designated color by adopting a different material. However, a light-emitting diode that directly emits white light would be more versatile when used with filters of different colors and serves as a convenient and economical approach to various practical needs. Thus, development of white LEDs has long been targeted by the related researchers and manufacturers.

For example, U.S. Pat. No. 6,351,069 has described the use of a fluorescent material which is activated by a blue light-emitting diode to fluoresce with yellow light by absorbing the received blue light, such as YAG:Ge fluorescent, in achieving the resultant white light emitting of the light-emitting diode. In order to improve the light-emitting diode in color rendering, the use of another fluorescent material fluorescing with red light when activated by blue light has been further proposed, so as to allow the light-emitting diode to give light more realistically.

In the conventional white light-emitting diode, an optical gel containing a fluorescent substance is applied on the LED chip and the light emitted by the LED chip has to pass through the optical gel to activate the fluorescent substance prior to being presented as white light. However, when applied directly to the LED chip, the optical gel may have the fluorescent substance precipitated unevenly on the chip, which leads to uneven thickness of the fluorescent substance over the LED chip. Thus, the light emitted by the LED chip passing through the optical gel activates an uneven amount of the fluorescent substance, which causes disparate illuminance of the light-emitting diode.

Please refer to FIG. 1 and FIG. 2 for schematic drawings of a conventional light-emitting diode and the light pattern of the same light-emitting diode. In order to solve the above problems, a remote coating technology has been developed, which, in the shown instance, involves covering an LED chip 10 with a coated layer of non-fluorescent-optical gel 21, and coating a layer of fluorescent optical gel 22 on the non-fluorescent optical gel 21, so as to prevent the fluorescent substance from directly depositing on the LED chip 10, thereby eliminating the uneven activation of the fluorescent substance and improving the light uniformity of the light-emitting diode.

However, as shown in FIG. 1, in practical use of the foregoing remote coating process where the non-fluorescent optical gel 21 is filled in a die holder of the light-emitting diode holder, since the adhesion between the non-fluorescent optical gel 21 and the die holder wall usually surpasses the cohesion of the non-fluorescent optical gel 21, the capillarity exists and causes the non-fluorescent optical gel 21 to climb along the die holder wall. Consequently, the non-fluorescent optical gel 21 forms a raised periphery adjacent to the die holder wall and in turn has the upper surface depressed, as shown in FIG. 1.

In the case shown in FIG. 1, the peripheral portion of the non-fluorescent optical gel 21 that climbs along the die holder wall has a tendency to push away the fluorescent optical gel 22, with the undesirable consequence that the light 30 emitted by the LED chip 10 in the die holder fails to hit the fluorescent optical gel 22 but instead goes out directly through the non-fluorescent optical gel 21. As a result, the light 30 missing the fluorescent optical gel 22 fails to activate the fluorescent substance and forms a light halation 31 around the light pattern produced by the light-emitting diode, as shown in FIG. 2, leading to disparate illuminance of the light-emitting diode.

Hence, the existing light-emitting diodes still have shortcomings in both structure and use to be addressed and solved. While the related manufacturers have spent much for solutions, there is still lack of a practical design so the currently available products remain far from perfect. It is thus the related manufacturers' common challenge to create a novel halation-free light-emitting diode holder.

In view of this need, the inventor of the present invention with his years of experience in this art, repeatedly researched and finally invented the herein disclosed halation-free light-emitting diode holder, thereby improving the existing light-emitting diodes in practicability.

### SUMMARY OF THE INVENTION

One objective of the present invention is to, with the attempt to overcome the defects of the existing light-emitting diodes, provide a halation-free light-emitting diode holder wherein a die holder is formed with a retaining portion on a second surface thereof for preventing the fluorescent-substance-free optical gel from climbing up along the second surface and forming a raised periphery, which thereby prevents a light halation appearing around the light pattern produced by the light-emitting diode.

Another objective of the present invention is to provide a halation-free light-emitting diode holder, wherein a die holder has nano-material layers on a second surface thereof so as to minimize the adhesion between the optical gel and the second surface, and thus prevent the optical gel from climbing along the second surface due to the capillarity, therefore being more utile.

Still another objective of the present invention is to provide a halation-free light-emitting diode holder, wherein a die holder is configured such that the area of a first surface is greater than the area of an opened-end, and the optical gel is impeded by gravity from climbing, thereby eliminating a light halation from appearing around the light pattern produced by the light-emitting diode, and improving the light-emitting diode in luminance uniformity, therefore being more utile.

The present invention achieves the objectives and solves the technical problems by adopting the technical scheme recited below. A halation-free light-emitting diode holder according to the present invention includes: a body having a die holder that includes a first surface, a second surface, and an opened end; and a retaining portion being provided on the second surface.

The present invention further achieves the objectives and solves the technical problems by adopting also the technical means proposed below.

In the aforementioned halation-free light-emitting diode holder, the retaining portion is formed as a raised segment.

In the aforementioned halation-free light-emitting diode holder, the retaining portion is a raised segment peripherally formed on the second surface.

In the aforementioned halation-free light-emitting diode holder, the retaining portion is formed as a dented segment.

In the aforementioned halation-free light-emitting diode holder, the retaining portion is a dented segment peripherally formed on the second surface.

In the aforementioned halation-free light-emitting diode holder, the retaining portion is formed as a crenelated segment.

In the aforementioned halation-free light-emitting diode holder, the second surface has a first region provided with a first nano-material layer, wherein the first region is smaller than or equal to the second surface in area.

In the aforementioned halation-free light-emitting diode holder, the second surface has at least one first region and at least one second region, wherein the first region is provided with a first nano-material layer while the second region is provided with a second nano-material layer.

In the aforementioned halation-free light-emitting diode holder, the area of the first surface is greater than the area of the opened-end.

The present invention achieves the objectives and solves the technical problems by further adopting the technical scheme recited below. A halation-free light-emitting diode holder according to the present invention includes: a body having a die holder that includes a first surface, a second surface, and an opened end, wherein the second surface has at least one first region; and a first nano-material layer provided on the first region.

In the aforementioned halation-free light-emitting diode holder, the first region is smaller than or equal to the second surface in area.

In the aforementioned halation-free light-emitting diode holder, the second surface further has at least one second region, wherein the second region is provided with a second nano-material layer.

In the aforementioned halation-free light-emitting diode holder, the second surface is provided with a retaining portion.

In the aforementioned halation-free light-emitting diode holder, the second surface is provided with a retaining portion formed as a raised segment.

In the aforementioned halation-free light-emitting diode holder, the second surface is provided with a retaining portion, which is a raised segment peripherally formed on the second surface.

In the aforementioned halation-free light-emitting diode holder, the second surface is provided with a retaining portion formed as a dented segment.

In the aforementioned halation-free light-emitting diode holder, the second surface is provided with a retaining portion, which is a dented segment peripherally formed on the second surface.

In the aforementioned halation-free light-emitting diode holder, the second surface is provided with a retaining portion formed as a crenelated segment.

In the aforementioned halation-free light-emitting diode holder, the area of the first surface is greater than the area of the opened-end.

The present invention achieves the objectives and solves the technical problems by additionally adopting the technical scheme recited below. A halation-free light-emitting diode holder according to the present invention includes: a body having a die holder that includes a first surface, a second surface, and an opened end, wherein the area of the first surface is greater than the area of the opened-end.

The present invention further achieves the objectives and solves the technical problems by adopting also the technical means proposed below.

In the aforementioned halation-free light-emitting diode holder, the body is of a structure of stacked multilayer ceramic.

In the aforementioned halation-free light-emitting diode holder, the second surface has a first region provided with a first nano-material layer, wherein the first region is smaller than or equal to the second surface in area.

In the aforementioned halation-free light-emitting diode holder, the second surface has at least one first region and at least one second region, wherein the first region is provided with a first nano-material layer while the second region is provided with a second nano-material layer.

In the aforementioned halation-free light-emitting diode holder, the second surface is provided with a retaining portion.

In the aforementioned halation-free light-emitting diode holder, the second surface is provided with a retaining portion formed as a raised segment.

In the aforementioned halation-free light-emitting diode holder, the second surface is provided with a retaining portion, which is a raised segment peripherally formed on the second surface.

In the aforementioned halation-free light-emitting diode holder, the second surface is provided with a retaining portion formed as a dented segment.

In the aforementioned halation-free light-emitting diode holder, the second surface is provided with a retaining portion, which is a dented segment peripherally formed on the second surface.

In the aforementioned halation-free light-emitting diode holder, the second surface is provided with a retaining portion formed as a crenelated segment.

As compared with the prior-art devices, the present invention has obvious advantages and beneficial effects. By the aforementioned technical schemes, the halation-free light-emitting diode holder of the present invention at least contributes to the following advantages and beneficial effects:

1. By the retaining portion formed on the second surface of the die holder, the fluorescent-substance-free optical gel is blocked from climbing along the second surface so as not to form a raised periphery that otherwise causes a light halation around the light pattern produced by the light-emitting diode.

2. By the nano-material layers provided on the second surface of the die holder, the adhesion between the optical gel and the second surface is reduced, so the optical gel is prevented from climbing along the second surface under the effect of the capillarity.

3. In the specially configured die holder, the area of the first surface is greater than the area of the opened-end, so the optical gel is prevented by the gravitation from climbing, thereby eliminating a light halation around the light pattern produced by the light-emitting diode, and in turn improving the luminance uniformity of the light-emitting diode.

In brief, the present invention relates to a halation-free light-emitting diode holder, which includes a body and a retaining portion. The body includes a die holder, and the die holder has a first surface, a second surface, and an opened end. The retaining portion is provided on the second surface. In virtue of the retaining portion, the optical gel is blocked from climbing along the second surface due to the capillarity. In addition, either having nano-material layers formed on the second surface, or having the area of the first surface greater than the area of the opened end can help prevent the optical gel from climbing along the second surface. Thereby, a light halation is eliminated from a periphery of a light pattern of the resultant light-emitting diode, and the light-emitting diode is improved in luminance uniformity. The present invention thus has the foregoing numerous advantages and beneficial effects, by which it makes significant improvement to the structure and functions to the product. Its obvious technical progress brings about useful and practical effects, and exactly superiors to the existing light-emitting diode products, thus being a novel, progressive and practical design.

### BRIEF DESCRIPTION OF THE DRAWINGS

The invention as well as a preferred mode of use, further objectives and advantages thereof will be best understood by reference to the following detailed description of illustrative embodiments when acquire in conjunction with the accompanying drawings, wherein:

FIG. 1 is a schematic drawing of a conventional light-emitting diode;

FIG. 2 depicts a light pattern of the conventional light-emitting diode;

FIG. 3A is a perspective view of a halation-free light-emitting diode holder according to a first preferred embodiment of the present invention;

FIG. 3B is a perspective view of a halation-free light-emitting diode holder according to a second preferred embodiment of the present invention;

FIG. 3C is a perspective view of a halation-free light-emitting diode holder according to a third preferred embodiment of the present invention;

FIG. 4A is a sectional view of the halation-free light-emitting diode holder according to the first preferred embodiment of the present invention;

FIG. 4B is a sectional view of the halation-free light-emitting diode holder according to the second preferred embodiment of the present invention;

FIG. 4C is a sectional view of the halation-free light-emitting diode holder according to the third preferred embodiment of the present invention;

FIG. 5A is a sectional view of a halation-free light-emitting diode holder according to a fourth preferred embodiment of the present invention;

FIG. 5B is a sectional view of a halation-free light-emitting diode holder according to a fifth preferred embodiment of the present invention;

FIG. 5C is a sectional view of a halation-free light-emitting diode holder according to a sixth preferred embodiment of the present invention; and

FIG. 6 is a sectional view of a halation-free light-emitting diode holder according to a seventh preferred embodiment of the present invention.

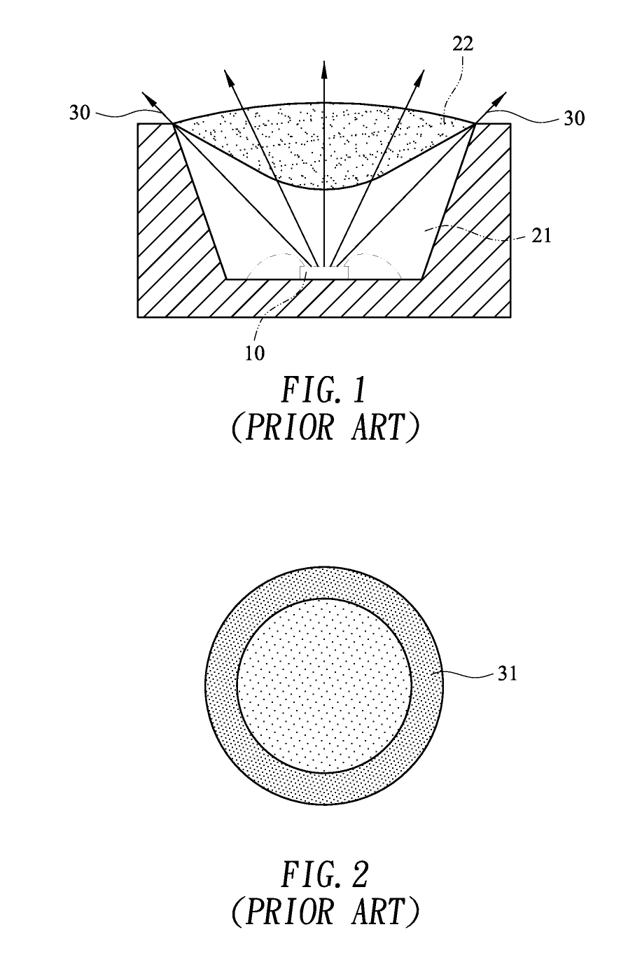

### DETAILED DESCRIPTION OF THE INVENTION

For further illustrating the means and functions by which the present invention achieves its objectives, the following description, to be read in conjunction with the accompanying drawings and preferred embodiments, is set forth as below to illustrate the implement, structure, features and effects of the halation-free light-emitting diode holder of the present invention.

The following preferred embodiments together with the accompanying drawings are made to clearly exhibit the above-mentioned and other technical contents, features and effects of the present invention. Through the exposition by means of the specific embodiments, people skilled in the art would further understand the technical means and effects the present invention adopts to achieve the above-indicated objectives. However, the accompanying drawings are intended for reference and illustration, but not limiting the present invention.

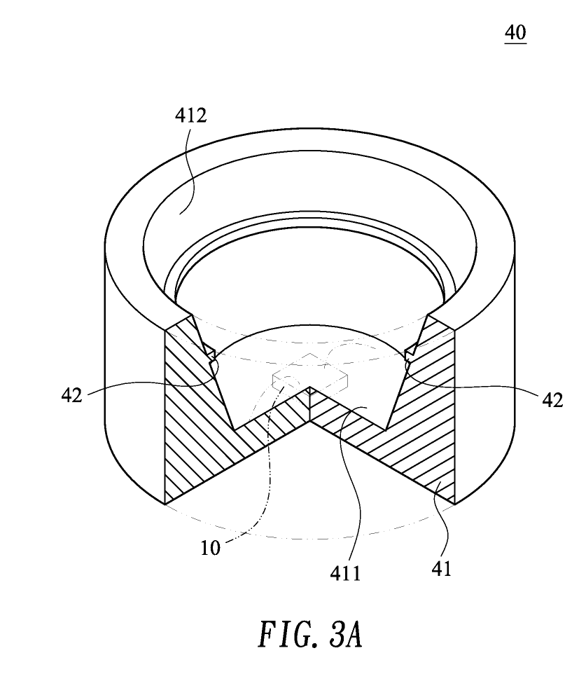

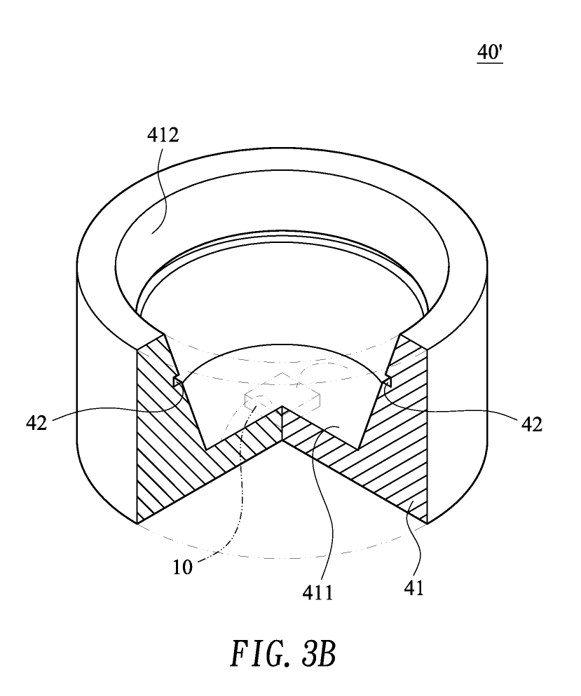

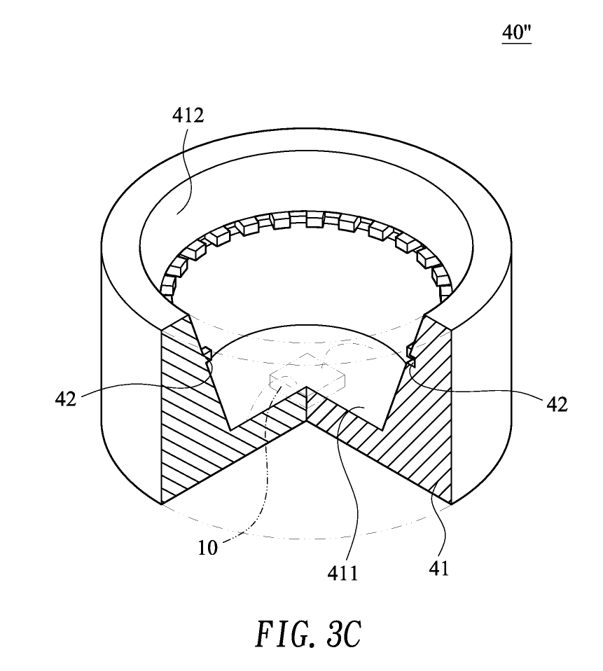

Please refer to FIG. 3A, FIG. 3B and FIG. 3C. FIG. 3A is a perspective view of a halation-free light-emitting diode holder 40 according to a first preferred embodiment of the present invention. FIG. 3B is a perspective view of a halation-free light-emitting diode holder 40′ according to a second preferred embodiment of the present invention. FIG. 3C is a perspective view of a halation-free light-emitting diode holder 40″ according to a third preferred embodiment of the present invention. In each of the preferred embodiments, namely the halation-free light-emitting diode holders 40, 40′, 40″, according to the present invention, there is a body 41 and a retaining portion 42 included.

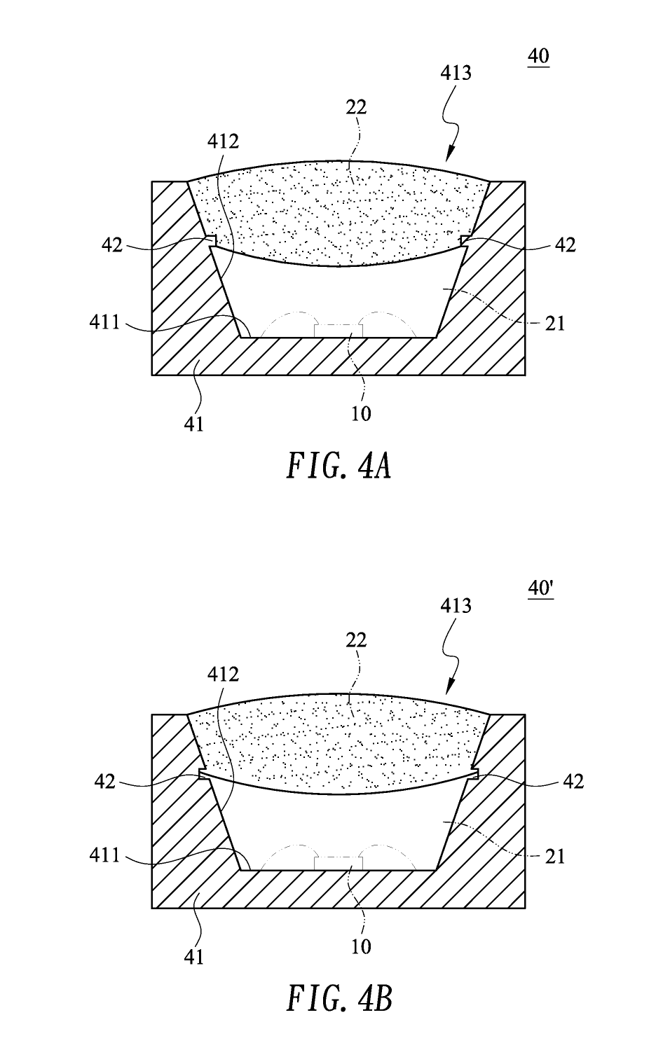

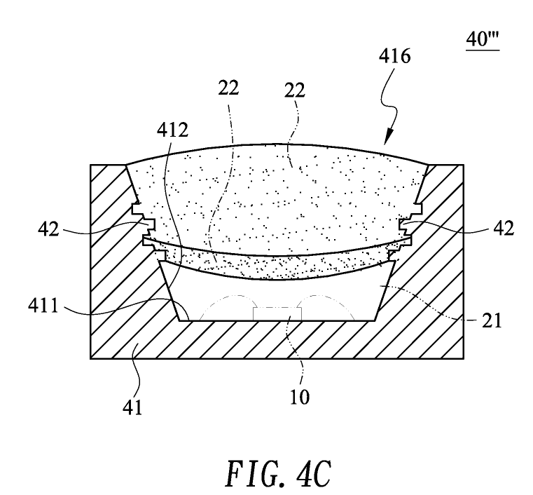

The body 41 has a die holder. The die holder has a first surface 411, a second surface 412, and an opened end 413 (seeing FIG. 4A and FIG. 4B as well). The die holder is meant to be a space defined by the first surface 411, the second surface 412, and the opened end 413.

The first surface 411 is a lower bottom of the die holder for receiving a light-emitting diode chip 10, which may be adhered to the first surface 411 by means of colloidal silver.

The second surface 412 forms a lateral wall of the die holder and generally is an inclined surface.

The opened end 413, as shown in FIG. 4A and FIG. 4B, is located at an opening of the die holder. Generally, the opened end 413 is greater than the first surface 411 in area, so as to allow most of the light emitted by the light-emitting diode chip 10 to scatter out.

Please refer to FIG. 4A, FIG. 4B and FIG. 4C. FIG. 4A is a sectional view of the halation-free light-emitting diode holder 40 according to the first preferred embodiment of the present invention. FIG. 4B is a sectional view of the halation-free light-emitting diode holder 40′ according to the second preferred embodiment of the present invention. FIG. 4C is a sectional view of the halation-free light-emitting diode holder 40″ according to the third preferred embodiment of the present invention. The retaining portion 42 is provided on the second surface 412 of the die holder. The retaining portion 42 is peripherally formed on the second surface 412 and its location defines a boundary between the non-fluorescent optical gel 21 and the fluorescent optical gel 22 that are to be filled in the die holder successively. Thus, the non-fluorescent optical gel 21 can only reach the altitude where the retaining portion 42 is positioned, and the retaining portion 42 serves to block the non-fluorescent optical gel 21 from climbing along the second surface 412. Thereby, the fluorescent optical gel 22 filled in the die holder has a substantially even thickness.

As can be seen in FIG. 3A and FIG. 4A, the retaining portion 42 may be a raised segment peripherally formed on the second surface 412 for directly blocking the non-fluorescent optical gel 21 from climbing along the second surface 412.

As can be seen in FIG. 3B and FIG. 4B, the retaining portion 42 may alternatively be a dented segment peripherally formed on the second surface 412. When the non-fluorescent optical gel 21 is filled in the die holder, the redundant non-fluorescent optical gel 21 can be received in the dented segment. Thereby, the non-fluorescent optical gel 21 is also prevented from climbing along the second surface 412 and forming a raised periphery.

Referring to FIG. 3C, the retaining portion 42 may alternatively be a crenelated segment, which has both a raised part to directly retain the non-fluorescent optical gel 21 from climbing along the second surface 412 and a dented part receiving the redundant non-fluorescent optical gel 21 therein.

Referring to 4C, the retaining portion 42 is a crenelated segment with raised and dented parts alternated vertically on the second surface 412. The raised part blocks the non-fluorescent optical gel 21 from climbing along the second surface 412. Where there is the non-fluorescent optical gel 21 somehow climbing beyond the raised part, the excessive non-fluorescent optical gel 21 can flow into the dented part. Thereby, the alternately arranged raised and dented parts of the retaining portion 42 can prevent the non-fluorescent optical gel 21 from climbing along the second surface 412 and forming a raised periphery of the non-fluorescent optical gel 21.

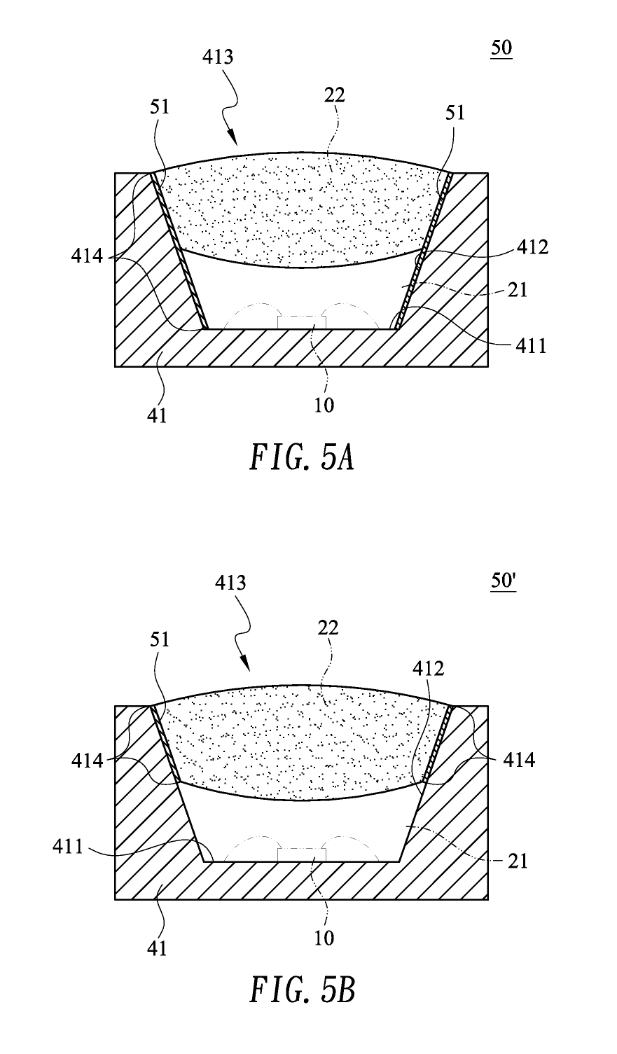

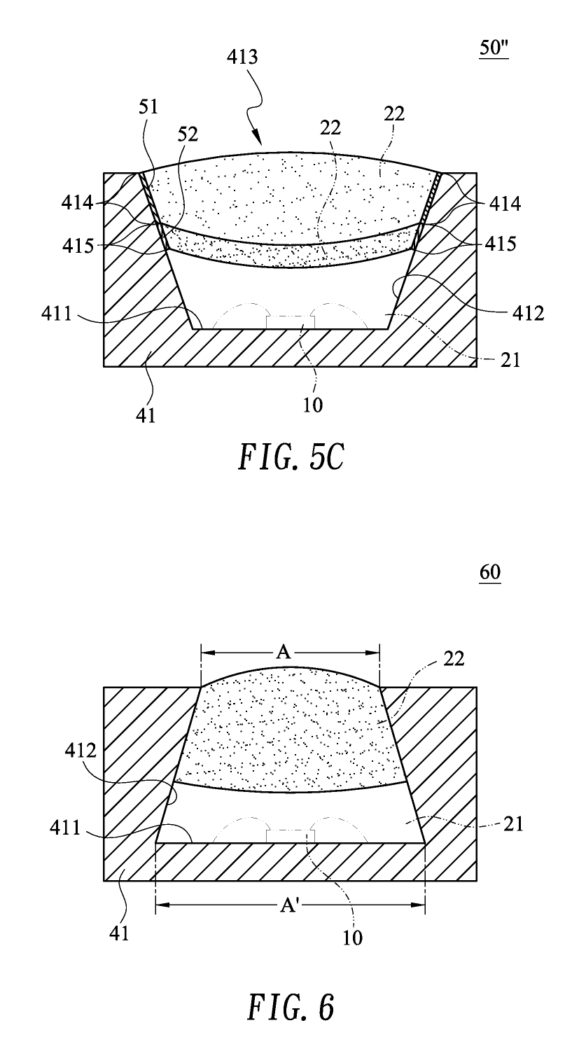

Referring to FIG. 5A, FIG. 5B and FIG. 5C. FIG. 5A is a sectional view of a halation-free light-emitting diode holder 50 according to a fourth preferred embodiment of the present invention. FIG. 5B is a sectional view of a halation-free light-emitting diode holder 50′ according to a fifth preferred embodiment of the present invention. FIG. 5C is a sectional view of a halation-free light-emitting diode holder 50″ according to a sixth preferred embodiment of the present invention. In addition to the above, it is also possible to prevent the non-fluorescent optical gel 21 from climbing along the second surface 412 by adjusting the superficial properties of the second surface 412. As can be seen in FIG. 5A and FIG. 5B, a first nano-material layer 51 may be provided in a first region 414 of the second surface 412. In one example shown in FIG. 5A, the first region 414 is equal to the second surface 412 in area, or as depicted in FIG. 5B, the first region 414 is smaller than the second surface 412 in area, so that the second surface 412 is partially covered by the first nano-material layer 51.

The first region 414 is a circular region on the second surface 412, and may be located at anywhere applicable on the second surface 412. As shown in FIG. 5B, the first region 414 may be settled close to the opened end 413. In such case, due to the designed superficial properties of the first nano-material layer 51 in the first region 414, the non-fluorescent optical gel 21 is prohibited from adhering to the second surface 412, not to mention climbing along it. Thereby, the non-fluorescent optical gel 21 is ensured with an even thickness without raised periphery, and in turn, the existence of a light halation 31 around the light-emitting diode can be eliminated.

Referring to FIG. 5C, the second surface 412 may have at least one first region 414 and at least one second region 415. Therein, the first region 414 is provided with the first nano-material layer 51 and the second region 415 is provided with the second nano-material layer 52. Each of the first region 414 and the second region 415 is a circular region on the second surface 412. Where it is desired to arrange multiple layers of fluorescent optical gel 22 in the die holder, the fluorescent optical gel 22 may be applied to corresponding sites in the first region 414 and the second region 415. By so doing, taking into consideration the different superficial properties of the first nano-material layer 51 and the second nano-material layer 52, both of the fluorescent optical gel 22 and the non-fluorescent optical gel 21 can be unobstructed from raised periphery, thereby ensuring the luminance uniformity of the light-emitting diode.

Similarly, where it is desired to arrange multiple layers of non-fluorescent optical gel 21 and multiple layers of fluorescent optical gel 22 in the die holder, the non-fluorescent optical gel 21 and the fluorescent optical gel 22 may be applied to corresponding sites in all the first regions 414 and second regions 415. This is done in a way so that the first regions 414 and the second regions 415 are arranged alternately, thereby ensuring that every layer of the optical gel 21, 22 are prevented from climbing along the second surface 412.

Furthermore, FIG. 6 is a sectional view of a halation-free light-emitting diode holder 60 according to another preferred embodiment of the present invention. It is also possible to change the shape of the die holder to make the first surface 411 of the die holder have an area A′ greater than an area A of the opened end 413. Thus, the non-fluorescent optical gel 21 placed at the bottom of the die holder is drawn by the gravitation and hindered from climbing. The body is of a structure of stacked multilayer ceramic.

The light-emitting diode holder in the present embodiment achieves the objective of eliminating the light halation 31 around the light pattern produced by the light-emitting diode by changing the configuration of the second surface 412 of the die holder. Preferably, a retaining portion 42 may be provided on the second surface 412 of the die holder, and a first nano-material layer 51 is also provided in at least one first region 414 of the second surface 412, or additionally the shape of the die holder is made in such a way that the area A′ of the first surface 411 of the die holder is larger than the area A of the opened end 413. Consequently, the light halation 31 is completely eliminated from around the light-emitting diode.

The present invention provides a halation-free light-emitting diode holder, which includes a body and a retaining portion. The body has a die holder, which includes a first surface, a second surface, and an opened end. The retaining portion is provided on the second surface. By the retaining portion, the optical gel in the die holder is blocked from climbing along the second surface due to the capillarity. Nano-material layers further formed on the second surface or the area of the first surface greater than the area of the opened end also helps to prevent the optical gel from climbing along the second surface. Thereby, a light halation is eliminated from a periphery of a light pattern of the resultant light-emitting diode, and the light-emitting diode is improved in luminance uniformity.

The present invention has been described with reference to the preferred embodiments and it is understood that the embodiments are not intended to limit the scope of the present invention. Moreover, as the contents disclosed herein should be readily understood and can be implemented by a person skilled in the art, all equivalent changes or modifications which do not depart from the concept of the present invention should be encompassed by the appended claims.

What is claimed is:

1. A halation-free light-emitting diode holder, comprising:
a body having a die holder, said die holder including a first surface, a second surface, and an opened end; and
a retaining portion provided on the second surface.

2. The halation-free light-emitting diode holder of claim 1, wherein the retaining portion is a raised segment peripherally formed on the second surface.

3. The halation-free light-emitting diode holder of claim 1, wherein the retaining portion is a dented segment peripherally formed on the second surface.

4. The halation-free light-emitting diode holder of claim 1, wherein the retaining portion is a crenelated segment.

5. The halation-free light-emitting diode holder of claim 1, wherein the second surface has a first region provided with a first nano-material layer, wherein the first region is smaller than or equal to the second surface in area.

6. The halation-free light-emitting diode holder of claim 1, wherein the second surface has at least one first region and at least one second region, wherein the first region is provided with a first nano-material layer while the second region is provided with a second nano-material layer.

7. The halation-free light-emitting diode holder of claim 1, wherein the area of the first surface is greater than the area of the opened end.

8. A halation-free light-emitting diode holder, comprising:
a body having a die holder, said die holder including a first surface, a second surface, and an opened end, wherein the second surface has at least one first region; and
a first nano-material layer provided on the first region.

9. The halation-free light-emitting diode holder of claim 8, wherein the first region is smaller than or equal to the second surface in area.

10. The halation-free light-emitting diode holder of claim 8, wherein the second surface further has at least one second region, wherein the second region is provided with a second nano-material layer.

11. The halation-free light-emitting diode holder of claim 8, wherein the second surface is provided with a retaining portion, which is a raised segment peripherally formed on the second surface.

12. The halation-free light-emitting diode holder of claim 8, wherein the second surface is provided with a retaining portion, which is a dented segment peripherally formed on the second surface.

13. The halation-free light-emitting diode holder of claim 8, wherein the second surface is provided with a retaining portion formed as a crenelated segment.

14. The halation-free light-emitting diode holder of claim 8, wherein the area of the first surface is greater than the area of the opened end.

15. A halation-free light-emitting diode holder, comprising: a body having a die holder, said die holder including a first surface, a second surface, and an opened end, the halation-free light-emitting diode holder being characterized in that the area of the first surface is greater than the area of the opened end.

16. The halation-free light-emitting diode holder of claim 15, wherein the body is of a structure of stacked multilayer ceramic.

17. The halation-free light-emitting diode holder of claim 15, wherein the second surface has a first region provided with a first nano-material layer, wherein the first region is smaller than or equal to the second surface in area.

18. The halation-free light-emitting diode holder of claim 15, wherein the second surface has at least one first region and at least one second region, wherein the first region is provided with a first nano-material layer while the second region is provided with a second nano-material layer.

19. The halation-free light-emitting diode holder of claim 15, wherein the second surface is provided with a retaining portion, which is a raised segment peripherally formed on the second surface.

20. The halation-free light-emitting diode holder of claim 15, wherein the second surface is provided with a retaining portion, which is a dented segment peripherally formed on the second surface.

21. The halation-free light-emitting diode holder of claim 15, wherein the second surface is provided with a retaining portion formed as a crenelated segment.
